(19) United States
(12) Patent Application Publication
(10) Pub. No.: US 2023/0339789 A1
(43) Pub. Date: Oct. 26, 2023

(54) Continuous Backwash Iron Media Reactor, A Wastewater Remediation Plant, and a Method of Remediating Wastewater

(71) Applicant: Höganäs AB (Publ), Höganäs (SE)

(72) Inventors: Hyunshik CHANG, Cary, NC (US); Carolyn HAWKINS, Cary, NC (US); Mohisin RASHEED, Hillsborough, NC (US); Louis LEBRUN, Cary, NC (US); Brett Hunt Boyd, Pompano Beach, FL (US)

(73) Assignee: Höganäs AB (Publ), Höganäs (SE)

(21) Appl. No.: 17/728,710

(22) Filed: Apr. 25, 2022

(51) Int. Cl. C02F 1/70; C02F 1/00

(52) U.S. Cl. CPC C02F 1/705; C02F 1/004; C02F 2101/22

(57) ABSTRACT

A continuous backwash reactor including a reactive medium including iron particles suitable for use in removing from wastewater ionic species reactive with the reactive medium including iron particles, by circulating iron particles in the continuous backwash reactor while passing said wastewater through said continuous backwash reactor and recovering a reject enriched in said ionic species therefrom. Further, a PORT wastewater remediation plant and a method of remediating wastewater.

### TECHNICAL FIELD

In the field of continuous backwash filters there is proposed a dynamic reductive iron media reactor and methods of its use, the dynamic reductive iron media reactor operating according to the principles of a continuous backwash sand filter.

### BACKGROUND

In the art it is well known to filter wastewater using a continuous backwash sand filters for removal of particulates which can attach to particulate sand held inside the filter and wherein the sand is in a self-replenishing process is treated to a process for dislodging the attached particulates from the sand, whereafter the sand is washed in a washbox in a counterflow process with a fraction of the effluent water, subsequently using the wash water for removal of the detached particulates forming a reject that is transported from the filter and either discarded if considered environmental not harmful, or treated to further processing in a wastewater remediation plant.

The technology behind continuous backwash sand filters were developed by Hjelmnér and Larsson during the 1970'ies and detailed e.g., in U.S. Pat. No. 4,126,546 or U.S. Pat. No. 4,197,201, and today find widespread use in wastewater remediation plants and other technological fields across the world.

During filter operation, influent process water enters the filter through a central influent feed chamber, where at the bottom of the feed chamber a set of radial distributors, typical radial arms, distributes the influent essentially evenly to the media or sand bed held inside the filter interior. During operation, the media retains suspended solids, contaminants, and/or nutrients, depending on the application. The purified filtrate fills the headspace above the media bed and exists the filter via a fixed effluent weir at the top of the filter.

And although the technology is well developed today, continuous backwash sand filtering technology remains a focus for continued technological development, c.f. e.g. WO 2019221663 A1 and others.

A restriction, however, for the use of continuous backwash filtering is the current effective limitation to sand as the only effective filter medium. Attempts to develop continuous backwash filters using other filtering media hitherto has not proven successful to a level wherein the developed filters have become commercially available and accepted the potential customers of such filters.

The present invention and disclosure concern a continuous backwash reactor, wherein sand as the filter media has been replaced at least in part by a reactive medium comprising iron particles. Surprisingly, using a general continuous backwash filter design, the present inventors have been able to make minor modifications to the general design, permitting iron particles to be comprised in the filter medium, which iron particles can chemically react inside the continuous backwash reactor of the present invention and disclosure with unwanted ionic species contained in the influent wastewater, which are subsequently removed by to their reaction with iron particles in the filter medium. It has been found by the present inventors that, surprisingly, the iron particles when following the directions contained herein, can be regenerated after reaction in a conventional manner using gravity supported backwash with effluent depleted in the aforesaid unwanted ionic species in the adapted continuous backwash reactor of the present invention, thereby forming an effluent depleted in an unwanted ionic species present in the influent and further forming a reject enriched in the aforementioned unwanted ionic species present in the influent.

The present invention and disclosure further relate to a wastewater remediation plant comprising the continuous backwash reactor of the present invention, and a method of remediating wastewater.

### SUMMARY OF THE INVENTION

In a first aspect and embodiment thereof, there is herein disclosed a continuous backwash reactor (1) comprising reactor walls (10a-e) defining a reactor interior (11), a reactor bottom (12) and a reactor top (13) with respect to Earth's gravity field; the reactor interior (11) containing a reactive medium comprising iron particles, the backwash reactor (1) arranged for obtaining an aqueous effluent by passage of an aqueous influent through the reactive medium for forming the aqueous effluent and spent reactive medium; and where, in the reactor interior (11), is arranged:
a washer unit (14) at the reactor top (13) for washing spent reactive medium in a gravity counter flow unit (144) with the aqueous effluent thereby forming an aqueous reject, the washer unit (14) further comprising a splash hood (141) and a reject weir (142) and arranged for permitting the aqueous reject to exit the reactor interior (11) via the reject weir (142);
a gas-lift arrangement (15) comprising a gas-lift conduit (150) defining a conduit cross-section of diameter (d), the gas-lift conduit (150) permitting a gas-flow from a gas-lift entry (151) arranged at the reactor bottom (12) to a gas-lift exit (152) arranged inside the washer unit (14) for lifting reactive medium from the reactor bottom (12) to the washer unit (14) using a non-reactive gas, thereby defining in use a circulation path and a circulation direction for the spent reactive medium from the reactor interior (11) via the gas-lift arrangement (15) and the washer unit (14) for returning to the reactor interior (11) as washed reactive medium; and wherein
the backwash reactor (1) further comprises an effluent weir (16) for permitting aqueous effluent exit from the reactor interior (11).

In a second aspect and embodiment thereof, there is herein disclosed a wastewater remediation plant (2) comprising an influent source (21), operatively connected to a reject tank (27) by a wastewater flowpath (28) for permitting a flow of wastewater to traverse the remediation plant (2) from the influent source (21) to the reject tank (27); the wastewater remediation plant (2) further comprising a continuous backwash reactor (1) according to any embodiment of the first aspect and embodiment thereof, arranged on the wastewater flowpath (28) between the influent source (21) and the reject tank (27), thereby defining a influent flowpath (281) for influent wastewater between the influent source (21) and the continuous backwash reactor (1) and a reject flowpath (282) between the continuous backwash reactor (1) and the reject tank (27); and where from the continuous backwash reactor (1) an effluent flowpath (282) for effluent is diverged from the wastewater flowpath (28); the wastewater remediation plant (2) further comprising at least one means for pumping water (25a,25b) from the influent tank (21) to the reject tank (27) arranged in the wastewater flowpath (28).

In a third aspect and embodiment thereof, there is herein disclosed a method of remediating a flow of wastewater comprising an ionic species reactive with a reactive medium comprising iron particles, by circulating iron particles in a continuous backwash reactor according to any embodiments of the first aspect and embodiment thereof, while passing the wastewater through the continuous backwash reactor (1) and recovering a reject enriched in the ionic species therefrom.

### BRIEF DESCRIPTION OF THE DRAWINGS

FIG. 1: A continuous backwash reactor according to the disclosure.

FIGS. 2A and 2B: Wastewater remediation plants according to the disclosure.

FIGS. 3A and 3B: Controller graphical interface screen dumps

FIG. 4: Br-tracer test results

FIGS. 5A and 5B: Se-wastewater remediation using remediation plant of the disclosure.

FIG. 6: Cr-wastewater remediation using remediation plant of the disclosure.

It is to be understood, that the embodiments shown in the figures are for illustration of the present invention and cannot be construed as being limiting on the present invention. Unless otherwise indicated, the drawings are intended to be read (e.g., cross-hatching, arrangement of parts, proportion, degree, etc.) together with the specification, and are to be considered a portion of the entire written description of this disclosure.

### DETAILED DESCRIPTION

In accordance with the present disclosure there is herein detailed a continuous backwash reactor (1) comprising a reactive medium comprising iron particles suitable for use in removing from wastewater ionic species reactive with the reactive medium comprising iron particles, by circulating iron particles in the continuous backwash reactor while passing the wastewater through the continuous backwash reactor (1) and recovering a reject enriched in the ionic species therefrom. Further a wastewater remediation plant (2) and a method of remediating wastewater are detailed.

In a first aspect and embodiment thereof, there is herein disclosed a continuous backwash reactor (1) comprising reactor walls (10a-e) defining a reactor interior (11), a reactor bottom (12) and a reactor top (13) with respect to Earth's gravity field; the reactor interior (11) containing a reactive medium comprising iron particles, the backwash reactor (1) arranged for obtaining an aqueous effluent by passage of an aqueous influent through the reactive medium for forming the aqueous effluent and spent reactive medium; and where, in the reactor interior (11), is arranged:
a washer unit (14) at the reactor top (13) for washing spent reactive medium in a gravity counter flow unit (144) with the aqueous effluent thereby forming an aqueous reject, the washer unit (14) further comprising a splash hood (141) and a reject weir (142) and arranged for permitting the aqueous reject to exit the reactor interior (11) via the reject weir (142);
a gas-lift arrangement (15) comprising a gas-lift conduit (150) defining a conduit cross-section of diameter (d), the gas-lift conduit (150) permitting a gas-flow from a gas-lift entry (151) arranged at the reactor bottom (12) to a gas-lift exit (152) arranged inside the washer unit (14) for lifting reactive medium from the reactor bottom (12) to the washer unit (14) using a non-reactive gas, thereby defining in use a circulation path and a circulation direction for the spent reactive medium from the reactor interior (11) via the gas-lift arrangement (15) and the washer unit (14) for returning to the reactor interior (11) as washed reactive medium; and wherein
the backwash reactor (1) further comprises an effluent weir (16) for permitting aqueous effluent exit from the reactor interior (11).

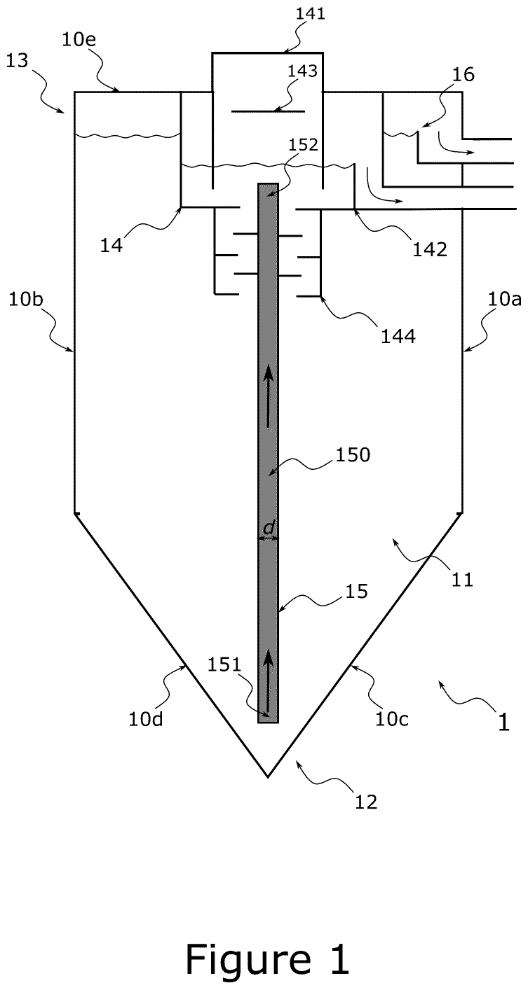

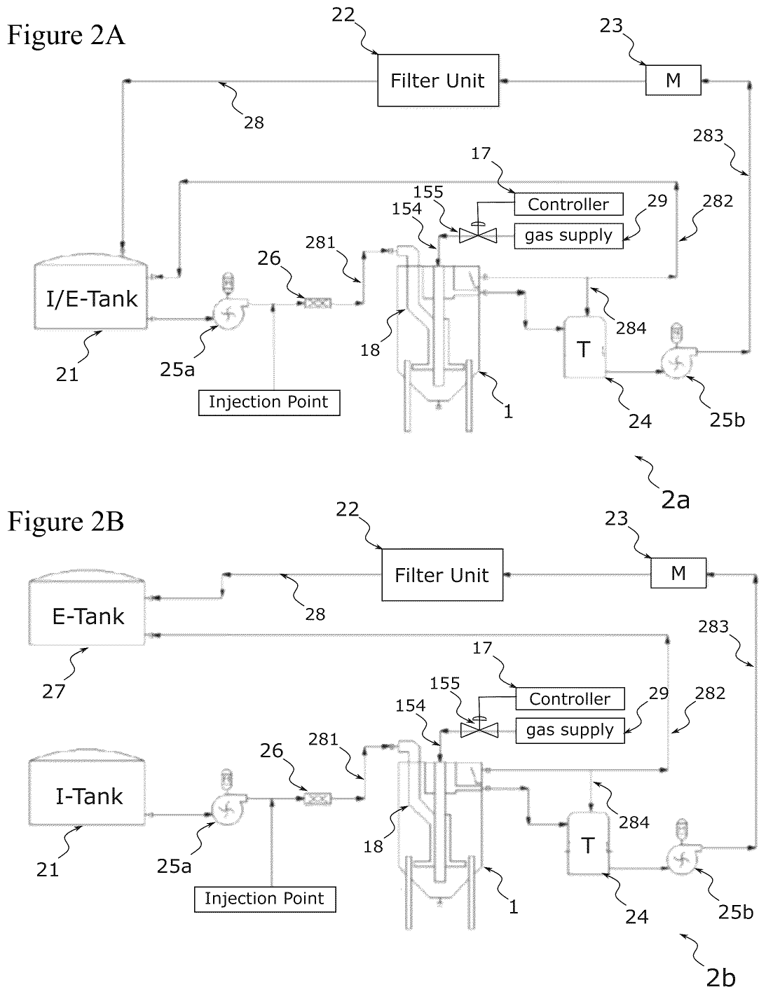

FIG. 1 details such parts of a generalized continuous backwash filter and reactor as is of interest to the present invention. A number of construction elements which are well-known to the skilled person, such as e.g., the influent feed arrangement (18) (c.f. FIGS. 2A and 2B) permitting the influent process water entrance to the filter through the central influent feed chamber, and the set of radial distributors, typical radial arms, arranged at the bottom of the feed chamber for distributing the influent essentially evenly to the reactive media held inside the reactor (1) or filter interior, or the gas-line supply inside the gas-lift arrangement (15) have been omitted from the present drawings and disclosure as these elements are known from the prior art and further remain unchanged from the prior art continuous backwash filters and accordingly also in the present continuous backwash reactor (1) of the present invention and disclosure.

As disclosed, it is a considerable advantage of the present invention and disclosure that reactive iron particles can form part of the filter medium, thereby becoming available for chemical reaction inside the interior (11) of the reactor (1).

In an embodiment thereof, there is herein disclosed a continuous backwash reactor (1), wherein the reactive medium comprises at least 80% by weight of the reactive medium of iron particles. While it is possible to use a mixture of reactive media, it is preferable for improved reactivity that most, if not essentially all, of the reactive medium consists of iron particles. Accordingly, in an embodiment the reactive medium comprises at least 85% by weight of the reactive medium of iron particles, preferably 90% by weight, 95% by weight, or even more preferably 97.5% by weight of iron particles. In a particularly preferred embodiment, the reactive medium consists of iron particles.

In an embodiment thereof, there is herein disclosed a continuous backwash reactor (1), wherein the iron particles consist of at least 80% by weight of iron. In general, a high iron content is desirable, however for commercial reasons lower grade iron may be useful in the present invention. Preferably, however, the iron content in the iron particles useful in the present invention shall be higher, preferably at least 85% by weight of the iron particles, more preferably at least 90% by weight of the iron particles, at least 95% by weight of the iron particles, or more preferably, at least 97.5% by weight of the iron particles is iron. The present experiments were satisfactory performed using iron particles having an iron content of more than 97% by weight of the iron particles used in the experiments.

In Table 1 a range of common physical characteristics have been listed for a sand filter medium suitable for use in a continuous backwash sand filter of the prior art. Such particles are fairly large with effective sizes on the order of 1 mm to 3 mm. Likewise the bed turnover rate is on the order of 0.05-0.1 m/h. It is a surprising effect of the present modifications that smaller iron particles have become suitable for use, which has enabled the present inventors to compensate for the much higher density of iron particles compared to sand particles.

The present experiments were therefore conducted using iron particles having approximately the same weight per particle as sand for backwash filtering, but the size of the iron particles was smaller by about a factor of 10 compared to an average sand filter media. With the modifications to the general setup disclosed herein, this size difference has enabled the present inventors to increase the bed turnover rate to between 0.5 to 0.8 m/h, which is faster than current bed turnover rates by at least a factor of 5.

In an embodiment thereof, there is herein disclosed a continuous backwash reactor (1) according to any previous embodiments of the first aspect and embodiment thereof, having a bed turnover rate of from 0.3 to 1.0 m/h, preferably from 0.5 to 0.8 m/h.

In an embodiment of the present invention, there is therefore herein disclosed a continuous backwash reactor (1) according to any previous embodiments, wherein the iron particles used as reactive medium do not have a dimension of length larger than 0.5 mm as measured by sieving. The effective size measured for the iron particles used in the present experiments was 0.17 mm, however these were very irregular (c.f. Table 1), thereby proving that particle regularity is not a discriminating factor in the present invention. Accordingly, is sufficient that the iron particles for use in the present invention are not more irregular than what is herein detailed. Likewise, since sieving is a well-known and simple standard tool for size exclusion determination, the application of more complex procedures is not requested. However, and preferably, the iron particles used as reactive medium do not have a dimension of length larger than 0.4 mm, 0.35 mm, 0.3 mm or more preferably 0.25 mm as measured by sieving.

In consequence of the switch from inert sand as filter bed to iron particles as reactive medium, a necessary modification in the present continuous backwash reactors (1) has been the substitution of air for a non-reactive gas, such as either nitrogen or argon.

Accordingly, in an embodiment thereof, there is herein disclosed a continuous backwash reactor (1) according to any previous embodiments of the first aspect and embodiment thereof, wherein the non-reactive gas contains at least 95% by weight of the non-reactive gas of either nitrogen (N₂) or argon (Ar) or combinations thereof.

Likewise, and in consequence of the changed reactor bed material to particles of iron, it is preferable to minimize the amount of iron contained in the reactor (1) construction itself, such as e.g., reactor walls (10a-e). Thereby circulation magnetization of the iron particles can be minimized or avoided.

Accordingly, in an embodiment there is herein disclosed a continuous backwash reactor (1), wherein the reactor walls (10a-e) are manufactured from a plastics material, preferably polyethylene or polystyrene.

A constructional change to the present reactor (1) and counter flow unit (144) made necessary by the increased bed turnover rate is to specifically expand certain included into the reactor (1) for permitting to realize the possibility of a high bed turnover rate.

In an embodiment thereof, there is herein disclosed a continuous backwash reactor (1), wherein the counter flow unit (144) defines an outer washer ring size having a size of from 4.5 d to 6 d.

In an embodiment thereof, there is herein disclosed a continuous backwash reactor (1), wherein the splash hood defines an inner size matching the outer washer ring size

In an embodiment thereof, there is herein disclosed a continuous backwash reactor (1), wherein the splash hood (141) comprises splash hood cover (143) arranged coaxially with the gas-lift conduit (151) along the circulation direction.

In an embodiment thereof, there is herein disclosed a continuous backwash reactor (1), wherein the splash hood cover is a flat panel.

In an embodiment of the present invention (c.f. FIGS. 2A and 2B), there is herein disclosed a continuous backwash reactor (1) connected to a controller (17) arranged for controlling at least a supply of the non-reactive gas to the gas-lift arrangement (15).

In an embodiment thereof (c.f. FIGS. 2A and 2B), there is herein disclosed a continuous backwash reactor (1) according to any previous embodiments of the first aspect and embodiment thereof, wherein the non-reactive gas is provided to the gas-lift arrangement (15) using a gas supply line (154) comprising a solenoid valve (155) controlled by the controller (17).

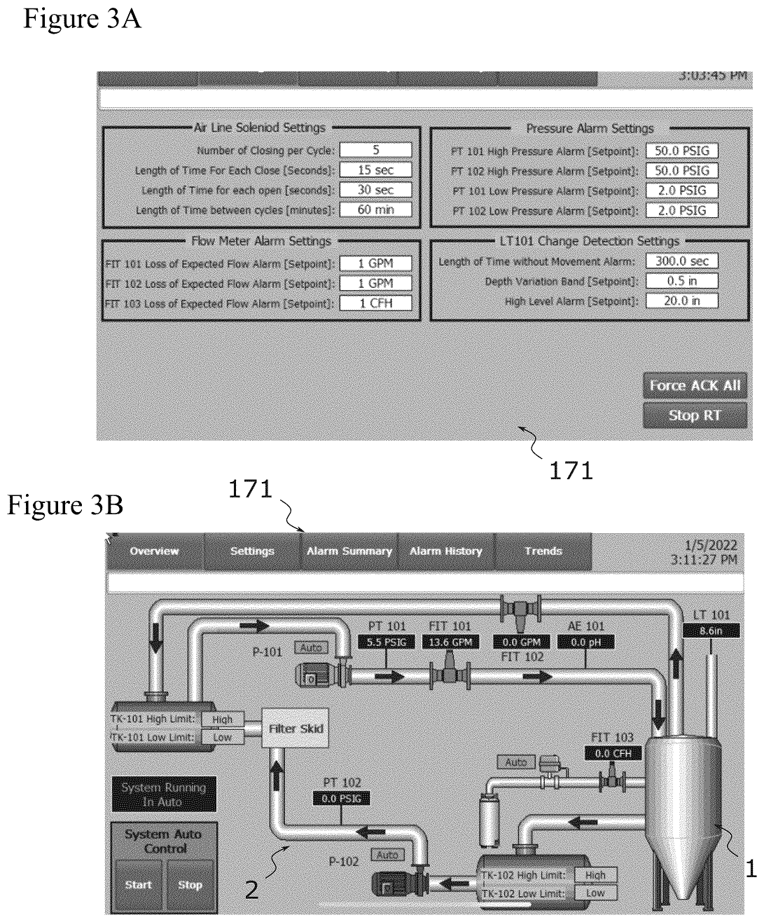

In an embodiment thereof (c.f. FIGS. 3A and 3B), there is herein disclosed a continuous backwash reactor (1) according to any previous embodiments of the first aspect and embodiment thereof, wherein the controller (17) is arranged for providing a periodic gas pulsation by acting on the solenoid valve (155).

This has been found to be advantageous in light of the increased bed turnover rates of the present invention compared to the prior art, which (in combination with the small size relative to the prior art filter sand) causes an increased propensity for clogging of the gas-lift conduit (150).

In an embodiment thereof (c.f. FIGS. 3A and 3B), there is herein disclosed a continuous backwash reactor (1) according to any previous embodiments of the first aspect and embodiment thereof, further comprising a pressure sensor in the washer unit (14) operatively connected to the controller (17) for permitting gas-lift movement monitoring.

Further, in an embodiment, the controller comprises control logic (c.f. FIGS. 3A and 3B) for operating one or more of the process elements (14,15,18, 25a-b). In a further embodiment (c.f. FIGS. 3A and 3B), the controller is operatively connected to a input and display system, such as a PC with keyboard, a mouse, and a screen connected, for permitting operator control and operation inspection using a graphical user interface (GUI).

In a second aspect and embodiment thereof (c.f. FIGS. 2A and 2B), there is herein disclosed a wastewater remediation plant (2) comprising an influent source (21), operatively connected to a reject tank (27) by a wastewater flowpath (28) for permitting a flow of wastewater to traverse the remediation plant (2) from the influent source (21) to the reject tank (27); the wastewater remediation plant (2) further comprising a continuous backwash reactor (1) according to any embodiment of the first aspect and embodiment thereof arranged on the wastewater flowpath (28) between the influent source (21) and the reject tank (27), thereby defining a influent flowpath (281) for influent wastewater between the influent source (21) and the continuous backwash reactor (1) and a reject flowpath (282) between the continuous backwash reactor (1) and the reject tank (27); and where from the continuous backwash reactor (1) an effluent flowpath (282) for effluent is diverged from the wastewater flowpath (28); the wastewater remediation plant (2) further comprising at least one means for pumping water (25a,25b) from the influent tank (21) to the reject tank (27) arranged in the wastewater flowpath (28).

In an embodiment thereof, there is herein disclosed a wastewater remediation plant (2), wherein the influent source (21) is an influent tank (21). Depending on the actual use on site, it may be advantageous to collect larger amounts of wastewater suitable for remediation within the remediation plant (2) of the invention, rather than running the plant (2) at lower than optimal capacity. In the present experiments, e.g., where experiments with chromium and selenium were conducted the use of influent and effluent tanks were particularly suited for avoiding heavy metal ion contamination to the environment.

In an embodiment thereof, there is herein disclosed a wastewater remediation plant (2), further comprising a filter unit (22) arranged on the reject flowpath (283). Thereby unwanted iron particle loss to the environment can be avoided. In an embodiment thereof, the filter unit (22) may comprise at least two filters in series in ascending filter class. In an embodiment thereof, the filters can be a 5 micron and a 1 micron pore-size cartridge filter. In the experimental plant of the present experiments, a 5/1 double filter as detailed above was sufficient to limit the filter exchange to twice a week.

In an embodiment thereof, there is herein disclosed a wastewater remediation plant (2) according to any previous embodiments of the second aspect and embodiment thereof, further comprising a magnet separator (23) arranged on the reject flowpath (283). This is particularly efficient in the present remediation plant (2) due to the use of iron particles as reactive medium.

In an embodiment thereof, there is herein disclosed a wastewater remediation plant (2) according to any previous embodiments of the second aspect and embodiment thereof, further comprising a mixer (26) arranged on the influent flowpath (281), preferably a static mixer (26). In some embodiments of the present remediation plant, this is advantageous in order to assure a uniform influent and consequently a uniform distribution of the contents of the influent in the reactor (1). In the present experiments, in particular the Br-circulation test required good inmixing prior to entry into the reactor (1) for optimal measuring of the bed turnover rate.

In an embodiment of a wastewater remediation plant (2) according to the present invention, the wastewater remediation plant (2) further comprises a gas source (29) for a non-reactive gas operatively connected for providing a non-reactive gas to the continuous backwash reactor (1) via the gas supply line (154).

In a third aspect and embodiment thereof, there is herein disclosed a method of remediating wastewater comprising an ionic species reactive with a reactive medium comprising iron particles, by circulating iron particles in a continuous backwash reactor according to any embodiments of the first aspect and embodiment thereof, while passing a flow of wastewater through the continuous backwash reactor (1) and recovering a reject enriched in the ionic species therefrom.

In an embodiment thereof, there is herein disclosed a method of remediating wastewater according to any previous embodiments of the third aspect and embodiment thereof, wherein the ionic species are ionic species of chromium (Cr), of selenium (Se), or mixtures thereof.

In an embodiment thereof, there is herein disclosed a method of remediating wastewater according to any previous embodiments of the third aspect and embodiment thereof, wherein the continuous backwash reactor (1) is comprised in a wastewater remediation plant (2) according to any embodiments of the second aspect and embodiment thereof.

### EXAMPLES

Test Setup

Tests were conducted in two phases, media lift test and contaminant treatability test using the remediation plant setup detailed in FIGS. 2A and 2B.

### Example 1—Media Lift Test

Recirculation Setup: FIG. 2A.
Influent: tap water with pH control to about 5.0 SU using sulfuric acid
Filtrate: directly went back to the influent tank
Reject: Filtered through the filter unit, then went back to the influent tank
Filtration unit consisted in two filters in series (5 micron and 1 micron pore-size cartridge filter). The filters were replaced twice per week.

Optimized Conditions for Best Media Movement:
Flow rate: total 1.6 m³/h (0.9 m³/h filtrate+0.7 m³/h reject)
N₂ gas condition: 207-241 kPa, 1.7-2.0 m³/h
Observed media moving speed when optimized: 0.5-0.8 m/h

### Example 2—Bromide Tracer Test

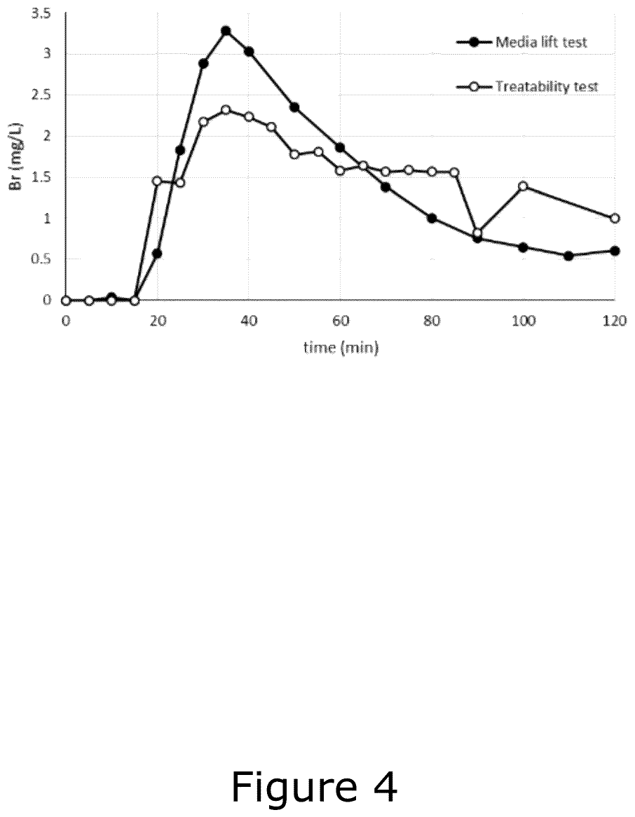

Bromide (Br) Tracer Test was Conducted to Confirm Plug Flow Reactor (PFR) Flow Pattern—FIG. 4
Dosing solution: Br 2000 mg/L in 2 L, one time injection
Injection point: influent line (281) before static mixer (26).
Injection flow rate: 1 L/min (total 2 min).
Sampling the filtrate from the time of injection with every 5- or 10-minutes interval up to 2 hours.

### Example 3—Contaminant Treatability Test

Single Pass Flow-Through Setup: FIG. 2B
Influent: Synthetic wastewater, 3.4 m³ per each test, the water composition is in Table 2. Main contaminant during Trial 1 and 2 was selenate [Se(VI)], and that during Trial 3 was hexavalent chromium [Cr(VI)].
Reject and filtrate were not recycled during the tests. Both were collected in a disposal tank.
Identical Br tracer test was conducted for comparison of flow conditions.
Flow rate was total 1.6 m³/h (1.4 m³/h filtrate+0.2 m³/h reject).

Test Results

### Example 2—Br-Tracer Test

FIG. 4. Br Concentration in Filtrate (mg/L)

The highest Br concentration was observed at 35 min after Br injection started in both tests, which shows the hydraulic retention time (HRT) of 35 min and confirms a compatible PFR-like flow pattern in both tests.

Steady state can be considered after 105 min of retention time (3 turnover time of 35 min HRT).

### Example 3—Contaminant Treatability Test Se/Cr

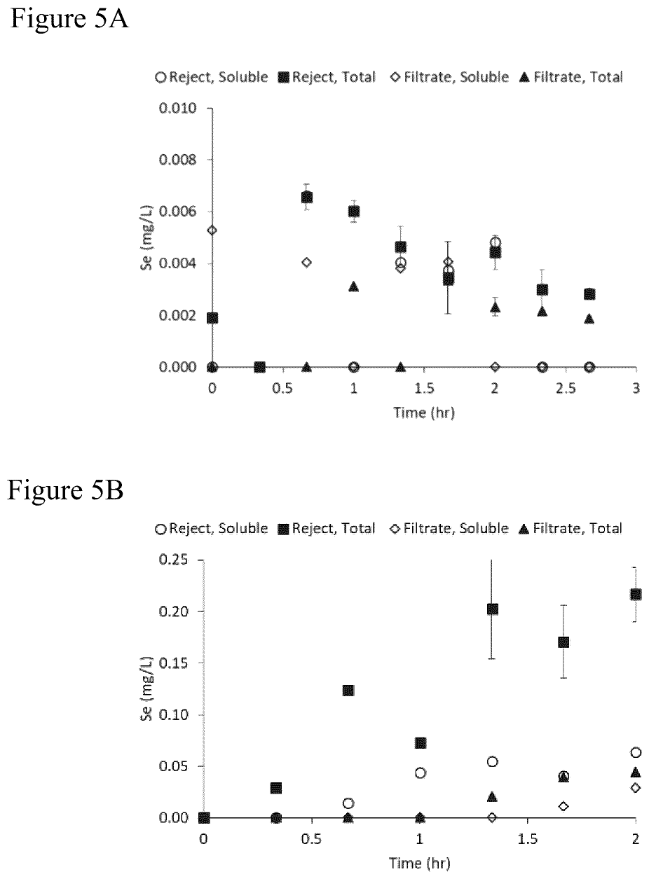

FIG. 5. A) Se Concentration Profile of 1 mg/L Se Test, B) Se Concentration Profile of 10 mg/L Se Test

Soluble Se removal at steady-state was almost 100% in 1 mg/L Se test and 99.4-99.7% in 10 mg/L Se test, respectively. On the other hand, steady-state total Se removal was 99.7-99.8% in 1 mg/L Se test and 97.8-99.6% in 10 mg/L Se test, respectively.

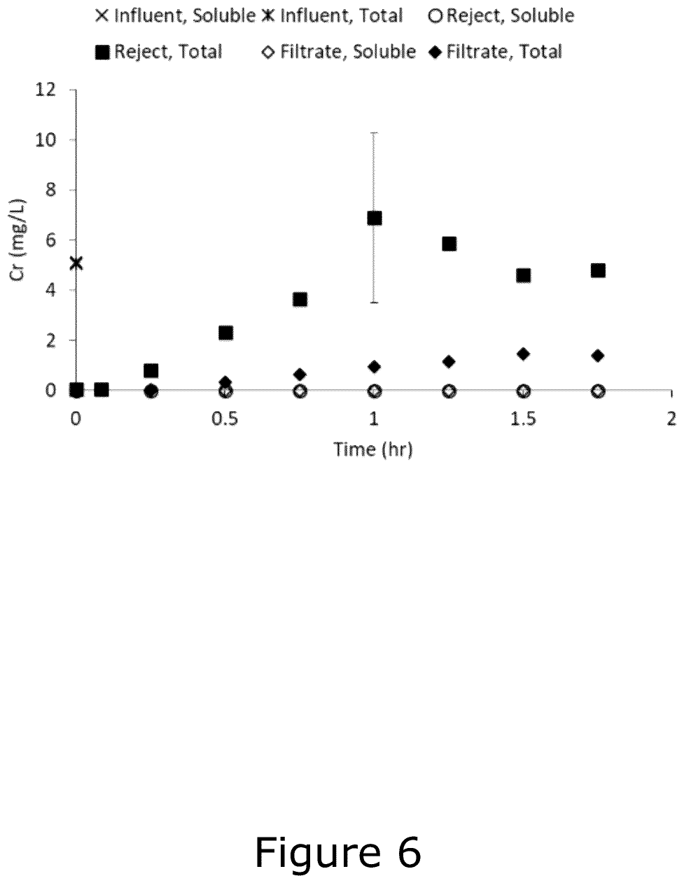

FIG. 6. Cr Concentration Profile of 5 mg/L Cr(VI)

All Cr in the influent (5 mg/L) was soluble Cr, which can be considered as Cr(VI). Soluble Cr [or Cr(VI)] removal at steady-state was 100%. However, total Cr in filtrate was about 1.4 mg/L, and total Cr in reject is about 4.8 mg/L. These results indicate strong reduction of Cr(VI) to Cr(III) and precipitates as particulate Cr, which can be removed by a post-filtration process.

Difference between sand media in DSF and Iron media in DRIM Reactor Operation, c.f. Table 1. Typical Sand media data from Dynasand manufacturer fact sheet.

TABLE 1

| | DSF | | | | Is the iron |
|---|---|---|---|---|---|
| | typical sand | | DRIM reactor | | media & |
| | media for | | iron media | | operation fit |
| | filtration | | for reaction | | for typical DSF? |
| Media effective | 0.9-2.3 | mm | 0.17 | mm | No |
| size (ES) | | | | | Order of |
| | | | | | magnitude small |
| Media uniformity | Less than 1.5 | | 2.0 | | No |
| coefficient | | | | | Grain size range |
| | | | | | is too large |
| Media grain shape | Sub-round to | | Very irregular | | No |
| | sub-angular | | | | Not suitable |
| Media composition | >98% silica | | >97% iron | | No |
| | dioxide | | | | Very different |
| Media reactivity | Inert | | Highly reactive | | No |
| | | | | | Not suitable |
| Bed turnover rate | 0.05-0.1 | m/h | 0.5-0.8 | m/h | No |
| | | | | | Order of |
| | | | | | magnitude faster |

Test water composition, c.f. Table 2.

TABLE 2

| Trial 1 | | Trial 2 | | Trial 3 | |
|---|---|---|---|---|---|
| | Conc. | | Conc. | | Conc. |
| Comp. | (mg/L) | Comp. | (mg/L) | Comp. | (mg/L) |
| Se (VI) | 1.0 | Se (VI) | 10.0 | Cr (VI) | 5.0 |
| Al | 5.0 | Al | 5.0 | Ca | 62 |
| P | 2.6 | P | 2.6 | Mg | 103 |
| TSS | 160 | TSS | 160 | Si | 9.2 |
| (Kaolinite) | | (Kaolinite) | | K | 3.8 |
| Na | 5.8 | Na | 5.8 | Na | 185 |
| pH | 4.0 SU | pH | 4.0 SU | SO4-S | 244 |
| | | | | Cl | 50 |
| | | | | Alkalinity | 297 |
| | | | | as CaCO₃ | |
| | | | | pH | 6.0 SU |

### CLOSING COMMENTS

Although the present invention has been described in detail for purpose of illustration, it is understood that such detail is solely for that purpose, and variations can be made therein by those skilled in the art in practicing the claimed subject matter, from a study of the drawings, the disclosure, and the appended claims.

The term “comprising” as used in the claims does not exclude other elements or steps. The indefinite article “a” or “an” as used in the claims does not exclude a plurality. A single processor or other unit may fulfill the functions of several means recited in the claims. A reference sign used in a claim shall not be construed as limiting the scope.

1. A continuous backwash reactor comprising reactor walls defining a reactor interior, a reactor bottom and a reactor top with respect to Earth's gravity field; said reactor interior containing a reactive medium comprising iron particles, said backwash reactor arranged for obtaining an aqueous effluent by passage of an aqueous influent through said reactive medium for forming said aqueous effluent and spent reactive medium;
and where, in said reactor interior, is arranged:
a washer unit at said reactor top for washing spent reactive medium in a gravity counter flow unit with said aqueous effluent thereby forming an aqueous reject, said washer unit further comprising a splash hood and a reject weir and arranged for permitting said aqueous reject to exit said reactor interior via said reject weir;
a gas-lift arrangement comprising a gas-lift conduit defining a conduit cross-section of diameter (d), said gas-lift conduit permitting a gas-flow from a gas-lift entry arranged at said reactor bottom to a gas-lift exit arranged inside said washer unit for lifting reactive medium from said reactor bottom to said washer unit using a non-reactive gas, thereby defining in use a circulation path and a circulation direction for said spent reactive medium from said reactor interior via said gas-lift arrangement and said washer unit for returning to said reactor interior as washed reactive medium; and wherein
said backwash reactor further comprises an effluent weir for permitting aqueous effluent exit from said reactor interior.

2. A continuous backwash reactor according to claim 1, wherein the reactive medium comprises at least 80% by weight of the reactive medium of iron particles.

3. A continuous backwash reactor according to claim 2, wherein the iron particles consist of at least 80% by weight of iron.

4. A continuous backwash reactor according to claim 1, wherein said iron particles do not have a dimension of length larger than 0.5 mm as measured by sieving.

5. A continuous backwash reactor according to claim 1, wherein said non-reactive gas contains at least 95% by weight of said non-reactive gas of either nitrogen (N₂) or argon (Ar) or combinations thereof.

6. A continuous backwash reactor according to claim 1, wherein said reactor walls are manufactured from a plastics material, preferably polyethylene or polystyrene.

7. A continuous backwash reactor according to claim 1, having a bed turnover rate of from 0.3 to 1.0 m/h, preferably from 0.5 to 0.8 m/h.

8. A continuous backwash reactor according to claim 1, wherein said counter flow unit defines an outer washer ring size having a size of from 4.5 d to 6 d.

9. A continuous backwash reactor according to claim 8, wherein said splash hood defines an inner size matching said outer washer ring size

10. A continuous backwash reactor according to claim 1, wherein said splash hood comprises splash hood cover arranged coaxially with said gas-lift conduit along said circulation direction.

11. A continuous backwash reactor according to claim 10, wherein said splash hood cover is a flat panel.

12. A continuous backwash reactor according to claim 1 connected to a controller arranged for controlling at least a supply of said non-reactive gas to said gas-lift arrangement.

13. A continuous backwash reactor according to claim 12, wherein said non-reactive gas is provided to said gas-lift arrangement using a gas supply line comprising a solenoid valve controlled by said controller.

14. A continuous backwash reactor according to claim 12, wherein said controller is arranged for providing a periodic gas pulsation by acting on said solenoid valve.

15. A continuous backwash reactor according to claim 12, further comprising a pressure sensor in said washer unit operatively connected to said controller for permitting gas-lift movement monitoring.

16. A wastewater remediation plant comprising an influent source, operatively connected to a reject tank by a wastewater flowpath for permitting a flow of wastewater to traverse said remediation plant from said influent source to said reject tank; the wastewater remediation plant further comprising a continuous backwash reactor according to claim 1 arranged on said wastewater flowpath between said influent source and said reject tank, thereby defining a influent flowpath for influent wastewater between said influent source and said continuous backwash reactor and a reject flowpath between said continuous backwash reactor and said reject tank; and where from said continuous backwash reactor an effluent flowpath for effluent is diverged from said wastewater flowpath; the wastewater remediation plant further comprising at least one means for pumping water from said influent tank to said reject tank arranged in said wastewater flowpath.

17. A wastewater remediation plant according to claim 16, wherein said influent source is an influent tank.

18. A wastewater remediation plant according to claim 16, further comprising a filter unit arranged on said reject flowpath.

19. A wastewater remediation plant according to claim 16, further comprising a magnet separator arranged on said reject flowpath.

20. A wastewater remediation plant according to claim 16, further comprising a mixer arranged on said influent flowpath, preferably a static mixer.

21. A method of remediating wastewater comprising an ionic species reactive with a reactive medium comprising iron particles, by circulating iron particles in a continuous backwash reactor according to claim 1 while passing a flow of wastewater through said continuous backwash reactor and recovering a reject enriched in said ionic species therefrom.

22. A method of remediating wastewater according to claim 21, wherein said ionic species are ionic species of chromium (Cr), of selenium (Se), or mixtures thereof.

23. A method of remediating wastewater according to claim 21, wherein said continuous backwash reactor is comprised in a wastewater remediation plant comprising an influent source, operatively connected to a reject tank by a wastewater flowpath for permitting a flow of wastewater to traverse said remediation plant from said influent source to said reject tank; the wastewater remediation plant further comprising said continuous backwash reactor arranged on said wastewater flowpath between said influent source and said reject tank, thereby defining a influent flowpath for influent wastewater between said influent source and said continuous backwash reactor and a reject flowpath between said continuous backwash reactor and said reject tank; and where from said continuous backwash reactor an effluent flowpath for effluent is diverged from said wastewater flowpath; the wastewater remediation plant further comprising at least one means for pumping water from said influent tank to said reject tank arranged in said wastewater flowpath.
